(19) United States
(12) Patent Application Publication
(10) Pub. No.: US 2011/0264488 A1
(43) Pub. Date: Oct. 27, 2011

(54) Audition System

(75) Inventors: Osamu Murayama, Saitama (JP); Akira Furukawa, Tokyo (JP); Takayuki Magata, Tokyo (JP)

(73) Assignee: Osamu MURAYAMA, Saitama (JP)

(21) Appl. No.: 12/678,139

(22) PCT Filed: Aug. 28, 2009
(86) PCT No.: PCT/JP2009/004231

§ 371 Date: Mar. 12, 2010

(30) Foreign Application Priority Data
Dec. 26, 2008 (JP) 2008-333584
Jun. 3, 2009 (JP) 2009-13368
Aug. 28, 2009 (JP) PCT/JP2008/050126

(51) Int. Cl. G06Q 99/00

(52) U.S. Cl. 705/12

(57) ABSTRACT

An audition system for general participation comprising a cell phone handset equipped with ID, an applications server connected to a network, such applications servers having a CPU which executes audition application and voting program, the aforementioned program, divides the review groups used as vote target which consists review by a vote of each stage of more applicants, the system program that assembles a group of applicants chosen by review of lower orders, then performs a higher level examination, and results in the final assessments, where a multiplex vote program of a first-in first-out (FIFO) system the performs higher level examination while continuing to review the lower level groups of whose numbers constitute higher level review group in an ongoing process at the same time the middle of review of lower orders gathered, a feature is included where the program removes the display of the review group for which review has ended.

### CROSS-REFERENCE TO RELATED APPLICATIONS

This application claims the benefit of being a national stage application of Japanese PCT International Application No. PCT/JP2008/050126, filed Aug. 28, 2009, which is based on Japanese priority application JP2008-333584, filed Dec. 26, 2008 that has matured into Japanese Patent Registration Japanese Patent No. 4312824, issued on May 22, 2009 and Japanese priority application JP2009-133681, filed Jun. 3, 2009 that has matured into Japanese Patent Registration Japanese Patent No. 4338779, issued on Jul. 10, 2009.

### TECHNICAL FIELD

This invention concerns an audition system where votes are made by using a cellular phone.

### BACKGROUND ART

Patent Documents 1 through 3 describe background art that includes a system where things are nominated by using a cellular phone.

Patent Document 1 describes a contest system comprising the use of a cellular phone as an input unit and a display unit for entering characters and displaying images and characters that communicates through the internet communication network and packet communication network through NTT DoCoMo's “i-Mode®” communicated packet processing part system.

To this patent document 1, the applicant of the contest and a voter operate the cellular phone, and they access through the above mentioned packet processing component, the programs for the application to the contest and the vote of the contest, and it is implemented by the central processing unit of the above contest server using a browser for Web searches, and “i-mode®” of above NTT DoCoMo implements a communication to the access from a cellular phone using the central processing unit, and an ID number is acquired from the cellular phone after communication is established, and the prevents double registrations from the same cellular phone using this ID number using the central processing unit, and an above voter is informed of the vote of the second preliminary (contest) for people of cover selection based on the result of the primary preliminary (contest) of the above voter, and, after a secondary preliminary (contest), the vote of the prefecture meeting is performed, and the vote of the national convention that is selection is performed, and it is disclosed in the last to inform the voter of the contest results.

Patent Document 2 relates to a method of evaluating the contests, and is concerned with the subject of a secondary evaluation of participants that passed the primary evaluations, it is also concerns the subjects of third appraisal of what furthermore passed the secondary assessments, where the results of the final selection are then disclosed.

In Patent Document 3, two or more images of all applicants are displayed in the display part of the cellular phone terminal at the same time as a vote type communication system, the image of a specific applicant is selected from among the display from among the applicant of two or more concerned, and pertains to a specific image selected and the method of enlarging the display in the display part of the cellular phone handset.

Patent Document 4 discloses the technology to protect user privacy by alternating the image of the displayed contestant with a still background control image, this technique lowers the probability of a camera capturing the image of the contestant with overlapping background control image.

Patent Document 5 discloses associating nine thumbnail images displayed in the cellular phone display with the numeric keypad of a cellular phone.

### PRIOR ART DOCUMENTS

### Patent Documents

[Patent Document 1] International Publication No. 02/ 091259

[Patent Document 2] International Publication No. 02/054311

[Patent Document 3] Japanese Laid Open Patent No. 2003-114955

[Patent Document 4] Japanese Laid Open Patent No. 2005-117163

[Patent Document 5] Japanese Laid Open Patent No. 2003-273971

### DISCLOSURE OF INVENTION

### Problems Solved by the Invention

Patented documents 1 through 3 disclose the use of cellular phones for audition voting, contests, etc. Further, patent documents 1 and 2, among patent documents 1 through 3, disclose that the system with which the work (person) chosen by a primary review progresses to a secondary review.

Patent document 1 as well as document 2 also includes a low level examination and a high level examination where the contest start for the higher review begins after examination of lower orders is completed.

Where there are few entrants (the number of applications is few), there is not that much of a problem with this method. When there are many entrants (the number of applications is many) it takes time for the first examination process, the second examination waits for the results of the first examination, and there is an extremely long period required for review. On the contrary, when many applicants are going to be examined during a predetermined period, they are narrowed down to one or two from a great many people suddenly, and smooth and impartial examination cannot be performed.

Moreover, an applicant may also want to know the results of their review fast, if time until the applicant learns the results is long, the applicant's interest will fade and the sense of realism will be lost. This is unfavorable for the organizers and sponsors of the audition system and the contest.

### Means For Solving Problems

The audition system concerning the present invention solving the above-mentioned problems is comprised of an application server connected by a network and cellular telephone having a unique ID, and the application server has a central processing unit for implementing the application and vote program of the audition. Examination of each phase is divided into examination groups comprised of a plurality of applicants. The program of the method provides the applicants to be chosen by the low level examination are continuously gathered, once selected move on to a high level examination, and reach the final examination. While the examination of the low level applicants is ongoing, at such stage when a number of selected applicants sufficient to compose a higher-level examination group for examination, the evaluation takes place at the same time as the low level examination is taking place, the program provides for the higher-level to be then examined in a first-in, first-out method. The program prevents multiple registrations from the same cellular telephone in the examination group unit by identifying the ID.

The audition system shortens the period of time required for the examination by way of the program performing the modes of application and vote in an examination stage of each phase in a parallel manner.

In addition, the audition system concerning the present invention contemplates having a feature for only the vote program. That is it includes the characteristics of having an application server which is connected by a network, a cellular telephone having unique ID for the constructed audition system, with application server having CPU (central processing unit) to execute the audition vote program, and the examination by the vote of the each phase is divided into the examination group becoming the vote subject comprising a plurality of applicants, the program of the method by which applicants are chosen by the low level examination are gathered, the high level group is examined, and reaches the final examination, the program prevents multiple voting from the same cellular telephone in the examination group unit by identifying the ID, while continuing the examination of the low level at the stage when the numbers of people to compose an examination group for high-level examination in the middle of the examination of the low level is gathered, the program of high-level examination is first-in first-out, additionally the program excludes the examination group where examination has finished from being the subject of display.

After the final examination by the main system, a television program and/or a meeting place can be determined, and the final selection can be performed by an authorized judge. In addition, the cellular phone in the present invention includes a cellular phone having key buttons made in a picture image and a display part displaying the character and a nonnumeric input unit where the unique ID is be able to be confirmed, and the bidirectional communication can be made, and the device with a confirmable unique ID may possibly be a mobile computer with terminal. In addition, all stages do not need to be examined in order to perform a low level examination and a high-level examination concurrently. For example, where there is examination from the first to the fifth, examination from the first to the fourth may be performed concurrently.

### Effects of the Invention

Since the invention is audition system through which general users participate with their own cellular phones, it can ensure fairness.

In addition, this invention can perform a low level examination and a high level examination in parallel at the same time, and therefore, even where there are a high number of applications, the period of time until the results for the final assessments can be shortened. Moreover, because this system can maximize recruitment time when compared with a conventional tournament method, the deadline of the last recruitment can be set several days before final examinations and therefore becomes particularly effective when the contest holders want to be able to choose candidates from the largest number of talented people.

Additionally, since the system is designed to remove the display information of the review group for which review has ended, the degree to which personal information can be diverted becomes very low.

### BRIEF DESCRIPTION OF THE DRAWINGS

FIG. 1 is a block diagram representing the configuration of one embodiment of the system concerning the present invention.

FIG. 2 is a diagram showing audition system process at different levels.

FIG. 3 is a figure which depicts the organization of the examination group.

FIG. 4 is a figure showing the formation of a primary round group from 3 examination groups.

FIG. 5 is a figure showing the whole examination process of the Audition System.

FIG. 6 shows the process of the group formation of the consolation match.

FIG. 7 depicts a flow chart showing the application/vote system.

FIG. 8 depicts the audition application process by the registered cellular phone.

FIG. 9 shows examples of the vote screen.

### DETAILED DESCRIPTION OF THE INVENTION

This best mode for carrying out the invention is described below based on a drawing sheet details.

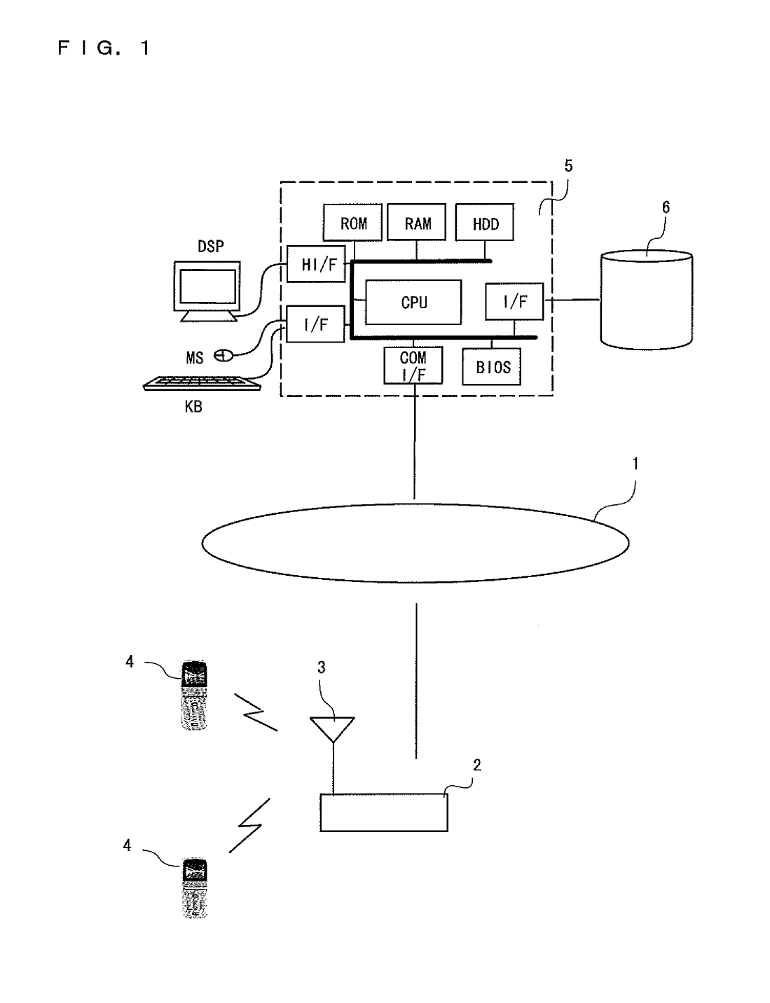

As shown in FIG. 1, the present invention concerning the audition system is comprised of Network 1 such as the Internet, Base Station 2 communicating to Network 1, though a center, Cellular Telephone 4, communicating through Base Station 2 and Radio Antenna 3, audition related information memory means comprising an Application Server 5, with database 6, the Audition System, when communicating through Network 1 is provided with a means to mutually authenticate connecting cellular phone 4, the cellular telephone of the applicant and voter having a unique ID, when communicating through Network 1, the communication interface device encrypts the transmission, wherein the picture image and character displaying part can also comprise a nonnumeric input unit.

Application server 5 connected with the afore-mentioned network 1, has a CPU that executes the program of the application of the audition and the vote on the audition. The afore-mentioned program divides the examination of each stage into an examination group that consists of a plurality of applicants. The program gathers the applicants chosen by low-level examination, and runs a higher-level examination, and results in the final assessments. The program prevents multiple voting for the above-mentioned units of the examination group from the same cellular phone by identifying the above-mentioned ID. The examination of low-level group with the program uses a FIFO (First-In First-Out) method and this allows the examination of high-level groups contemporaneously at a stage when a specified number of people that compose the higher-level examination group have been gathered from the examination of low-level examination groups. The program then excludes the examination group that has been finished and removes display information of that finished group.

The program can perform the application phase and voting in the various examination phases in parallel mode.

When there is the access from the audition applicant and a voter, application server 5 executes the program of the audition application and the vote. The audition applicant and voter use cellular telephones 4 to obtain access. It is to be understood that in the case of the present invention, application server 5 may execute only the process concerning the vote.

With the afore-mentioned CPU, the encrypted communication of SSL in the two-way authentication is executed for access from the cellular phone. After the data communication is established, ID is acquired from the cellular phone and multiple voting from the cellular phone to the same examination group is prevented by using the ID authentication with CPU of the above-mentioned application server. Said voters are informed of voting results for the next stage voting which is made up of the people selected applicable based on the previous poll of said voters, vote of the next level is henceforth is repeated and a voter is informed of a selection result in the final.

The above-mentioned cellular phone 4 displays a screen where images of all of the applicants, that are the plurality of people who are to be selected from on the form, where one key button corresponds to each person and the image corresponds with the key button pattern and is displayed at the same time in the above-mentioned display part. It is assumed the composition in which the above-mentioned images are displayed in the above-mentioned display part provide details when the image of a specific applicant is selected with the above-mentioned key button corresponding to the on screen display from among two or more displayed applicants.

The hardware of such applications servers 5 can use general-purpose servers computers, and consists of input parts, such as CPU, ROM, RAM, HDD, BIOS, a communications interface part (COM I/F), Keyboard KB, and Mouse MS, and a display DSP. Among these, ROM, RAM, HDD, BIOS, and a communications interface part (COM I/F) are connected with said central processing unit (CPU) through the buss, and Keyboard KB and Mouse MS are connected with said CPU through human interface HI/F.

In the configuration, a read-only memory is storage device for exclusive use of a read out storing a system program. The CPU is started by a system program memorized by a BIOS and ROM, and the central processing unit has the function executing various processes according to the program (an application program) present in the random access memory.

In addition, the central processing unit (CPU) also has a function to which the operation result of the above-mentioned system program, etc., is displayed on a display by making the signal from an input part into a trigger, and RAM has the function for the above-mentioned CPU to memorize a program or the data that it is necessary to properly carry out various top level processes.

The communication interface is made to manage the input and output of a hard disk, communications section interface part, the input part 18, and display.

The display DSP consists of a CRT or LCD monitor and has the function to display the input data from the operation result outside of the CPU by the control of the CPU.

The input units such as the central processing unit (CPU), the read-only memory (ROM), the random access memory (RAM), the hard disk, the communications interface part, the key board or the mouse and the display unit are connected on a central processing unit (CPU) mutually through the bus.

The base station 2 of a cellular telephone, equipment usually managed by mobile telephone service operators, works to transmit information in order to connect with the cellular phone handset 4 by wireless communication in the cell (when it is PHS (Personal Handyphone System), it is microcell) which is reciprocally covered.

Also, application server 5 functions as a WWW server providing a Web Site (and can be referred to as an application “information desk” site) providing a web page to implement various means of the present invention or the functional steps on the world wide web of the Internet.

Cellular telephone 4 of an audition applicant and a voter, having the ability to communicate with base station 2 of the cellular telephone, also having SSL communication ability which transmits and receives browser reading and e-mail through network 1, a function to receive and display screen information of the audition site, a selecting means when it votes by an audition is included, the screen display capable of also displaying a plurality of applicants in response to a key button at the same time, and having the ability to be configured with a feature to focuses on and display information about the specific applicant selected from the above mentioned plurality of applicants.

Application server 5 is a server computer comprised of memory storing ID data of the cellular telephone which received from application software and cellular telephone 4 including the control of cellular telephone 4 and SSL two-way authentication function and database 6 to communicate.

The previously mentioned application server 5, having memory which records the mail addresses of registered participants, functions as a confirmation function and duplication prevention function at the time of such applicant entering the audition, the duplication prevention function of the above-mentioned mail address, and the function that notifies said voters of vote results of the next step which made the person to be selected applicable to vote based on the poll of said voters, a vote of the second level is henceforth is repeated, and is equipped with the capability to inform a voter of finals selections result.

The network can be accessed from cell phone handsets 4, such networks include, for example, i-Mode®, EZweb® and the Yahoo® mobile phone networks.

An applications server 5 is connected to a network 1 in order to supply the contents to the external cellular phone 4, this applications server 5, having an application database sent by the audition applicants, connects with the database 6 which stores the has an exclusive distinguishable ID of cellular phone 4 of an audition applicant or a voter.

The ID number, of the cellular phone 4 which an audition applicants uses, it is data showing the ID numbers for identifying at the time of communication through a network, a suitable ID number, the unique IMSI (International Mobile Subscriber Identity) number saved on the SIM (Subscriber Identity Module) card with which a mobile phones is equipped, or its dependent data is preferable. An ID number may not be restricted to a number, but may also be ID data using characters. The applications server 5 which communicates information through the cellular phone 4 and a network 1, through this ID number is obtained at the time of SSL encrypted communication, a cellular phone 4 is able to be specified.

At the time of registration of the cellular phone 4, after applications server 5 and cell phone 4 establish SSL encrypted communication connection, and when an applications server 5 transmits a command to the cellular phone 4, the ID of the cell phone 4 is acquired and cellular phone 4 is registered by storing above-mentioned identification in the database of an applications server 5.

Henceforth, when a second access of the applications server 5 from the same cellular phone 4 takes place, a registration check is carried out and applications server 5 searches out registered identifiers in its databases, and duplicate entries are rejected and double votes are refused.

After cellular phone 4 previously accesses the audition site and applications server 5 acquires ID from the cell phone 4 by the aforementioned commands, applications server 5 can recognize cellular phone 4 as a partner and enable an automatic log-in improve convenience of the user.

Cellular phone 4 can sign-in to database 6, by way of having already finished logging in application server 5, and data can be registered to database 6.

As mentioned before, if the link was forwarded from another site, and the member is also a recognized member of the group, after establishing connection by the above-mentioned SSL encryption communication, an applications server 5 acquires the ID of the cellular phone 4, and it can register with the database 6.

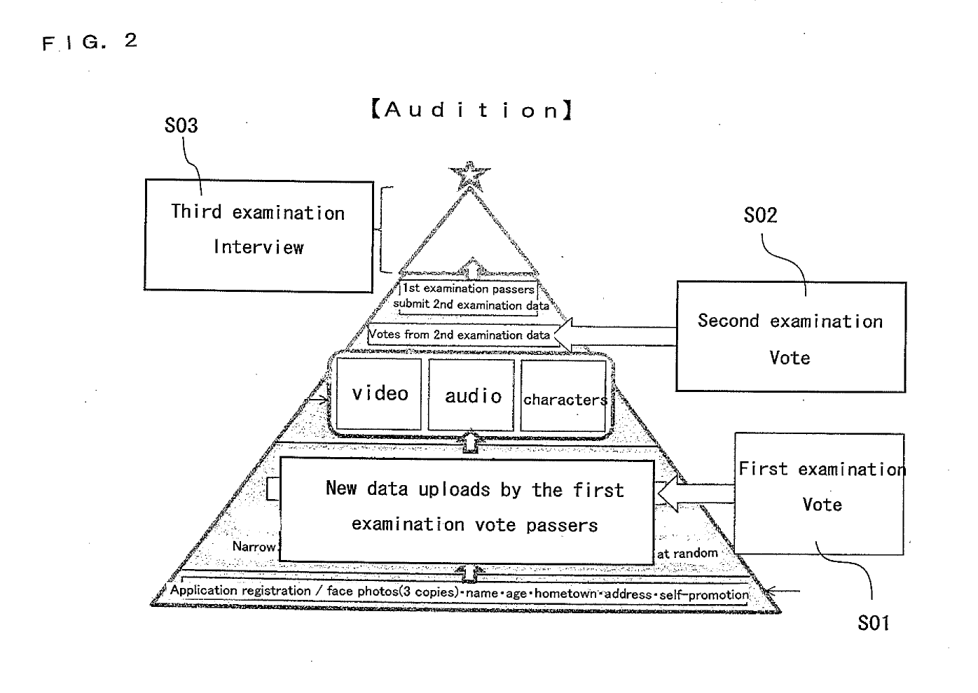

As shown in FIG. 2, the first examination of the audition is carried out in step S01, the second examination vote of step S02 can be performed concurrently with the first examination, and the third examination of step S03 is performed as a final stage audition by the interviews of the meeting format for the final stage examination. Although it is illustrated by Steps S01-S03 for simplicity, the examination of the many stages may be concurrently performed by as a first-in first-out between step S02 and step S03.

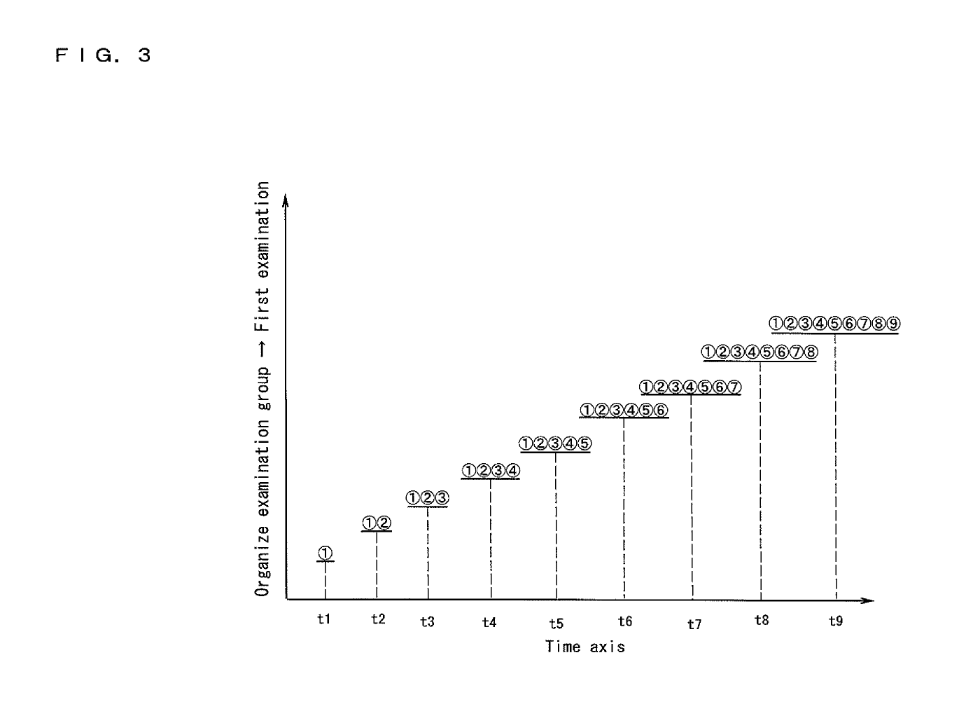

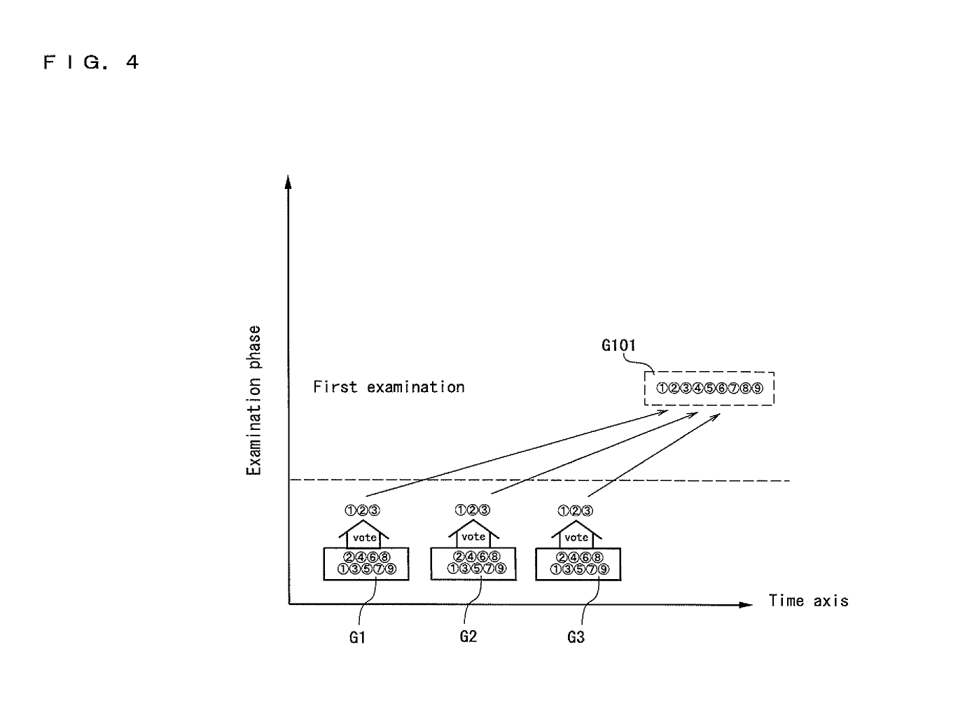

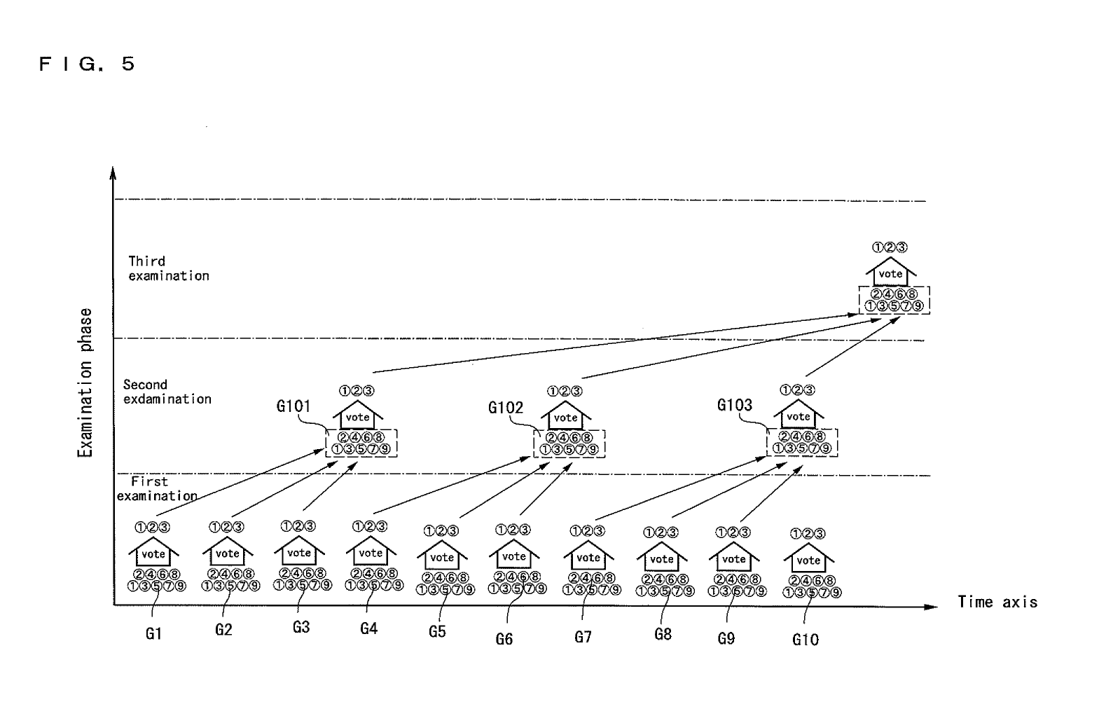

The vote is performed with the first in first out method. As shown in FIG. 3, at first when the first examination of the first group G1 is performed when there are nine applicants gathered. A qualified voter may make one vote for this group of applicants, and for example, three people are elected. The above mentioned three elected people where selected from among nine people and thereby passed the first examination and advance to the second examination vote. On the other hand, as shown in FIG. 4, these successful candidates are gathered into a group of nine persons who are chosen from groups G2 and G3 which are gathered after the first group G1, and together undergo the second level review. As shown in FIG. 5, these nine people participate in a second audition by the same method as the first Web audition, and the three highest ranking people advance to the Web audition of the third examination, without waiting for the end of the second examination (in a First-In First-Out method).

As for how to select three people, for example, the method how a poll chooses three people among the group that a turns out more than 100 people begins sequentially, the period of time is limited, and after a group is formed it is limited to three days, and how to select three high scoring people at the end of the time period is also considered.

As for the granting of the rights to vote, a method of giving the ability to vote only once for each examination group, as well as methods which only give the right to vote once a day are considered. If it is a method that gives only one chance to vote for each group, a vote is permitted the voter to full group in the each phase once.

As stated above, since by making every nine person group applicable for examination it becomes possible to move up the examination in a short period of time, except the final assessments, the applicant can know the examination result of the stage to last examination early, and forgetting due to a time lag after of being informed of the result is eliminated. It is understood that although in the example one review group is made from nine persons and three persons were elected, the number of people are not restricted to this.

The second examination (higher-level examination) can be assumed to be a vote that uses audition data that is more detailed than the first examination. For instance, in the flash image data, the applicant's real character, special skills, acting ability, and star appeal can be evaluated. For example, in this picture image, it is possible through use of browser technology such as AdobeFlashLE 3® of Adobe Systems Corporation, and Macromedia® FlashLite, although the review of the information is possible, downloading the data cannot be done.

Moreover, by offering audio data, the voice of the candidates, such as singing skill and acting talent, as well as instrument performance may be offered, it is also possible to offer a short video clip showing the candidates talents and sex appeal for evaluation.

In the above-mentioned second review, a voter can send a support message for an applicant, it is possible that a temporary blog can be prepared and said voters and candidates are able to communicate through this blog. Moreover, because poll results are displayed in real time, the data is open until the results are closed.

In levels other than the final examination, screen layouts are arranged in order with the order of votes, through this method, the person whose popularity is the highest can be known among nine people displayed on the screen, and this can be taken into account when voting.

Moreover, the screen layout order can be adjusted if at predetermined times, for example every 3 seconds and then refreshed roulette style, it is expected that the vote result that is due to the individual recognition characteristic to a particular location on the screen will be avoided. In this case, vote will is shown by pushing the particular button, and one can shift to the vote mode in the fixed screen by fixing a screen.

When the top three people were selected from each of the groups from the first group G1 to the third group G3, and the total number of people selected from the initial groups becomes nine people; group G101 of the second examination is formed. In addition, after the end of the examination, the information about the group is no longer displayed on the screen, therefore, personal information does not remain open and available for a prolonged time.

FIG. 5 shows an application of this principal over time on the horizontal axis, where Group G1 to G10 from the first to the tenth, with nine applicants constituting a group, the number is put in order as applied. Now, the turn of the first examination of each group G1-G10 becomes the turn according to the number, the vote for the first group G101 receiving the second examination consists of each three applicants chosen from each of the first group G1 to the third group G3, it is possible for evaluation to be performed earlier than the evaluation of the fifth group of the first level groups, G5, it is possible for second examination vote for the second group G102 to take place earlier than the examination of the eighth group G8 of the first level examination.

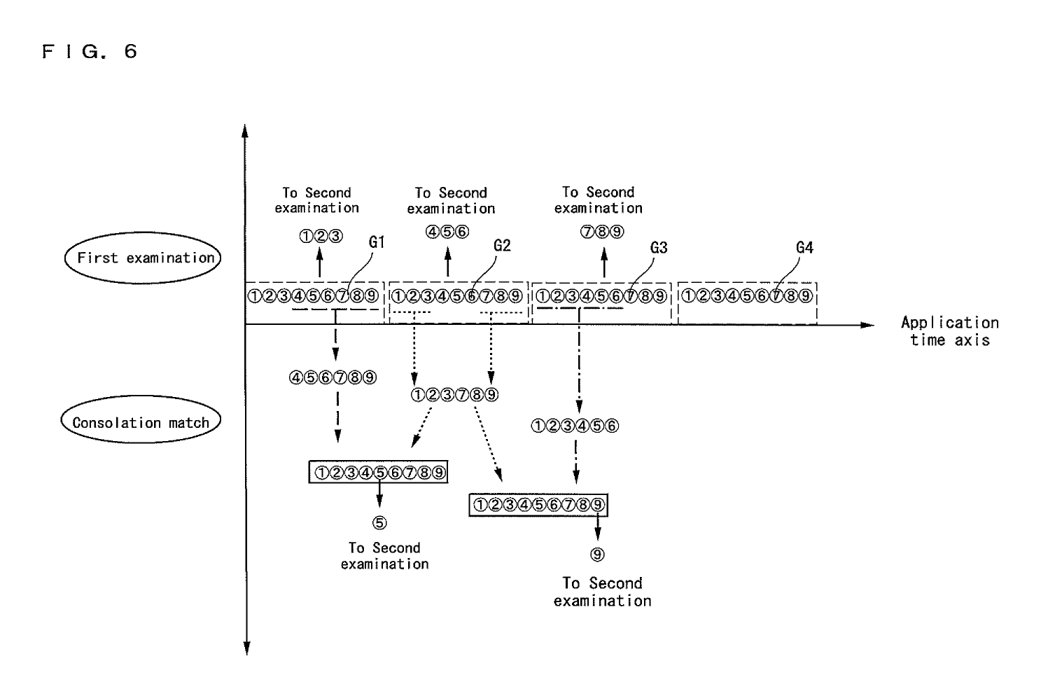

FIG. 6 shows a process of the group formation of the consolation match. The contestants for examination in the consolation match are gathered from the contestants that existed in the group but were not selected in the first examination at first stage intermixed with applicants who applied later.

For example, the 18 applicants defeated in the first through third groups G1-G3 are divided into two groups of nine people each, one person is selected from each group, and these people are revived for the second examination. It is to be understood that there are many methods as well as the above in the pattern of the revival of defeated contestants, but, wherein the examination of the revival of defeated contestants is preformed side by side with other examination and runs at the same time like the FIFO, an efficiency of the examination improves.

By introducing a consolation match, opportunity can not only be given to the applicant defeated in an examination at a specific level, but by combining a new applicants with the applicants who lost a specific level's examination according to the said article, the new applicant's examination waiting time can be shortened and screening times can be adjusted to that selected point.

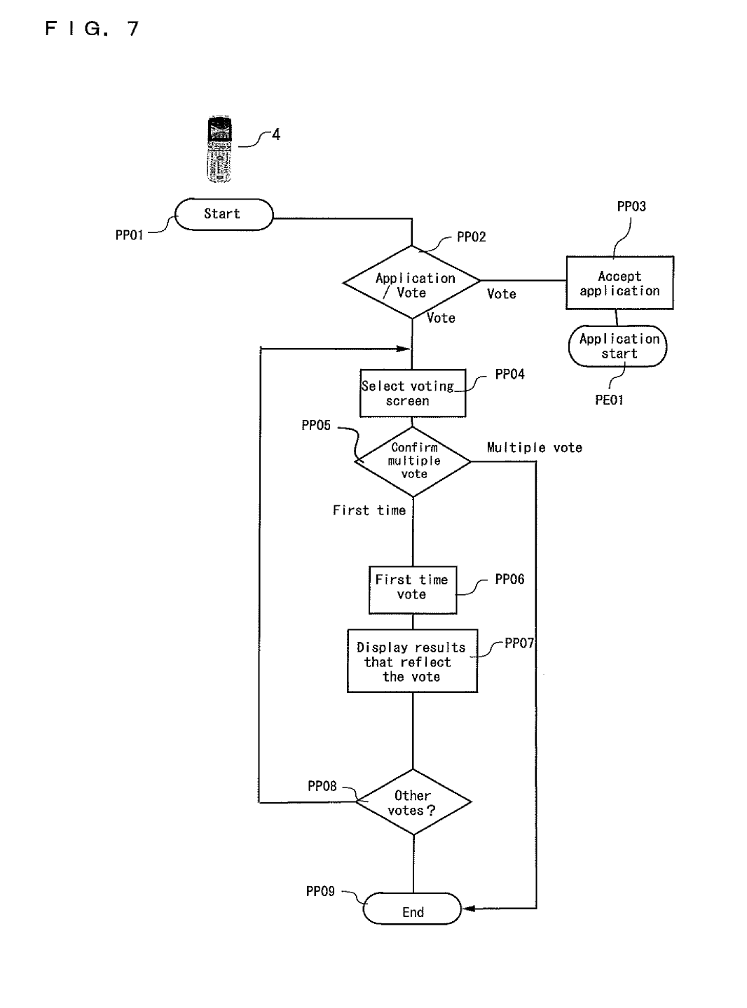

FIG. 7 shows the flow chart of application/voting system. It is possible to participate in the vote from a non-registered cellular phone 4 if cellular phone 4 is a member of another site.

First, the user of a cell phone 4 accesses a network from cell phone 4 at step PP01, and opens an audition site.

The user of handset 4 chooses either to be a candidate or to vote when the selection screen appears on cellular phone screen. When the option for application is chosen, the candidate enters from the application acceptance screen in step PP03 and steps for the prescribed application procedure. The subsequent contents of the application procedure serve as a similar procedure from step PE01 of FIG. 7.

When the vote option is selected in step PP02, the voting screen in step PP04 is selected. A feature of the invention this system, enables voting in multiple examination levels concurrently by choosing the specific vote level.

In step PP04, for example, when the second examination stage is chosen, the system confirms whether a vote has been made with cellular phone 4 with peculiar ID for the specific group of the second examination stage. If history on which a vote for the above-mentioned specific group in the past is found, the system recognizes an attempt at multiple voting and the system proceeds to step PP09 and the process ends.

When the multiple voting is not confirmed in step PP05, the voter is authorized as a first time voter, and voting becomes possible in step PP06.

When the vote in step PP06 becomes effective, poll results that reflect the vote are displayed on the screen of cellular phone 4 in step PP07, whether the vote influenced poll result and by how much can be recognized by sight.

Though the voting right to a specific group that uses cellular phone 4 with peculiar ID here was used up, when other groups that remain the voting right still exists, and the vote for other groups can be continued by a selection in step PP08.

When the voter lacks the desire to vote again in step PP08, a termination screen can be selected to end the process and it will lead to step PP09.

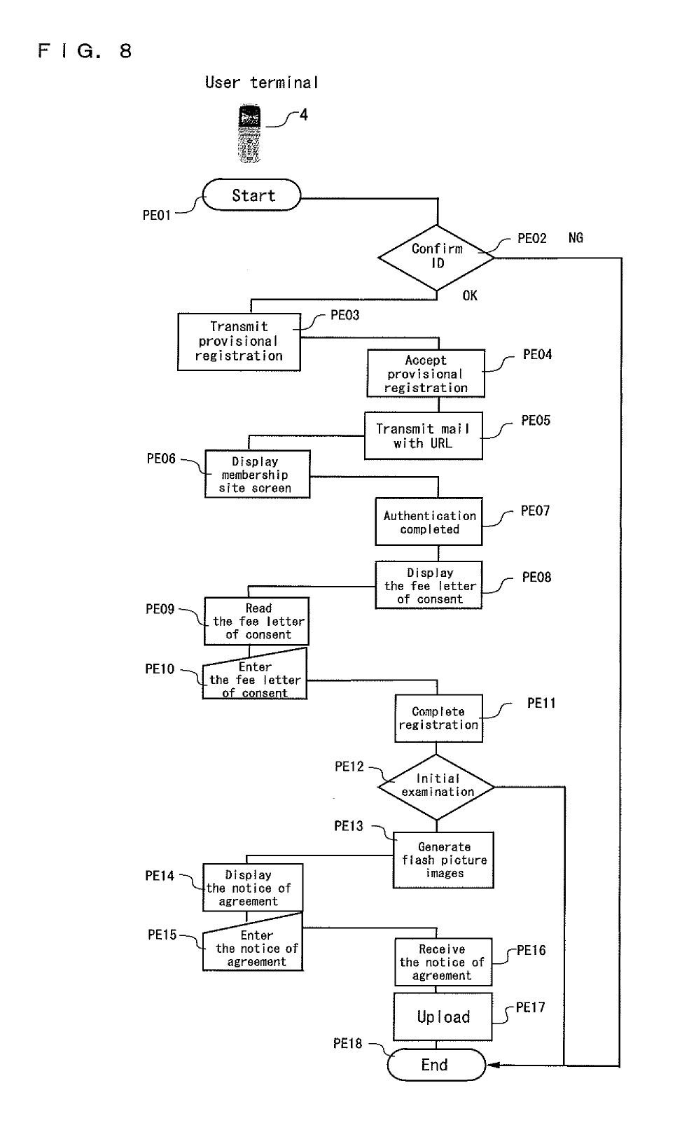

FIG. 8 shows the audition application process by the registered cellular phone. In the left side, a process of cellular phone 4, the right side shows a photographic processing by application server 5.

The audition applicant accesses the network from cellular telephone 4 in step PE01, and the audition site is opened.

In step PE02, application server 5 compares with database 6, and above-mentioned cellular telephone 4 is informed by way of a mail when the mail address data which have been transmitted from cellular telephone 4 is the ID of the cellular telephone with the record that was able to already finish one access, and information verification is completed.

When there is ID confirmation of cellular telephone 4 in step PE02, the provisional registration data of the audition is transmitted to application server 5 in step PE03, and provisional registration is done, and the mail address of the cellular phone is dispatched, and provisional registration is accepted in step PE04, and a mail in which a URL was listed for the above mail address in step PE05 is transmitted.

Here, if this is the cellular telephone of which cellular telephone 4 is registered with definitely, the mail in which the membership site URL from application server 5 was contained is received, and the information such as official member regulations is confirmed by the screen display of the membership site in step PE06, and provisional registration data can be entered.

The provisional registrant data includes entering a mail attached photographs (three still images having the same background), a screen name, age, hometown, self-promotion, and registration of hopes category for public data from the application screen. Further still, the real name and address of the person to contact, a telephone number, and mail address is entered as closed private data for verification use.

In addition to the personal information data included in the provisional registration data, the application number data, and the ID number of cellular telephone 4 acquired in SSL encryption communication, information is managed whenever an applicant unit connects to the system with a specific key, the other data regard to whom the applicant is can be retrieved.

Application server 5 ensures that substance of the provisionally registered information is correct in step PE07, and authentication is completed.

Then, application server 5 dispatches the particulars of the fee letter of consent to cellular telephone 4 in a mail in step PE08.

In step PE09, cellular telephone 4 can be confirmed to have read the contents of the fee letter of consent on the screen of cellular telephone 4.

When applicant agrees to the particulars of the fee letter of consent, the applicant operating cellular telephone 4 dispatches the message of the fee agreement to application server 5 in step PE10, application server 5 completes the registration of the applicant in step PE11, and applicant is charged using an ID number to cellular telephone 4 by the other process.

The initial registration data stored in database 6 in step PE12 receives format examination by displaying information on a display unit connected to application server 5.

Further still, the person concerned with audition confirms the provisional registration data which the applicant entered on the application screen, and, for example, inspects whether the format of the attached photograph is an offensive or improper photograph.

After the format inspection is completed, in step PE13 flash picture images are generated from the three still images photographed using the same background of the photographs attached to the e-mail, further still, the pictures images of nine people are processed and image thumbnails are entered on one screen from the above flash picture images for the nine people.

After the thumbnail creation process, a digital watermark can be randomly generated and encoded into the flash picture image slideshow to strengthen security and ensure that the image transmitted from the provider.

The flash picture image for which the editing is completed is transmitted to cellular phone 4 of the applicant in step PE13, if an applicant agrees to particulars in step PE14, a notice of agreement is entered in step PE15, and application server 5 receives a presentation approval in step PE16.

Once presentation approval is received, and application server 5 uploads the thumbnail flash picture image in step PE17, and it is shown, and a job task is completed in step PE18.

In the above, it is conceivable that a communication is started from step PE11 by making the agreement subject such as fee letters of consent are displayed in the screen of the opening to cellular telephone 4 beforehand to enable determination of the advisability of giving approval.

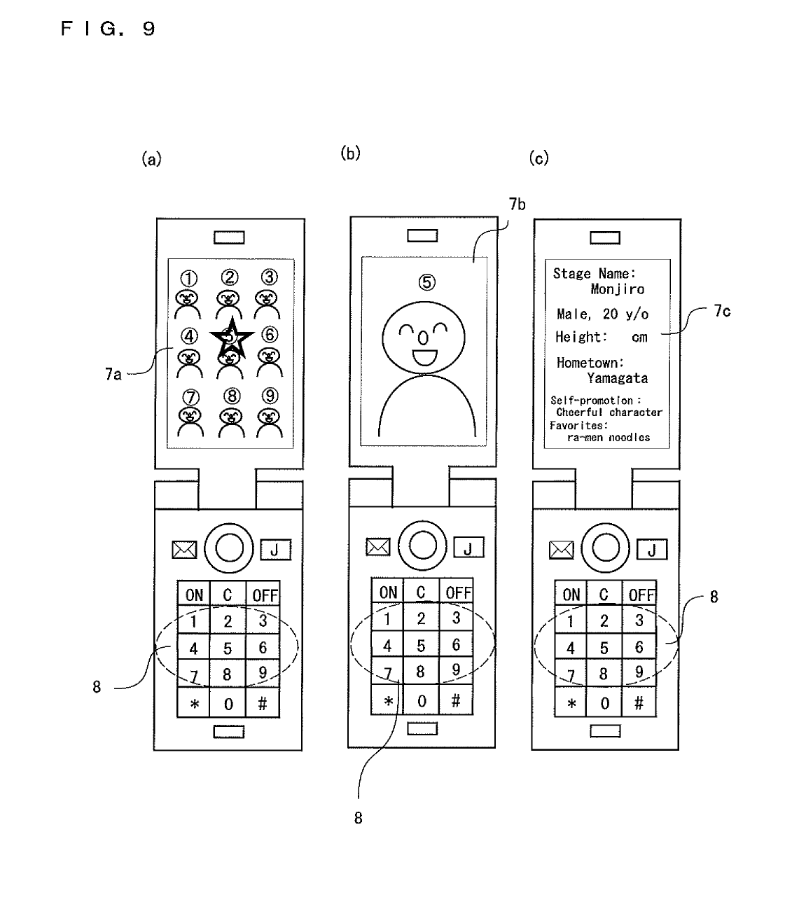

FIG. 9 (a)-(c) shows the example of the flash picture image screen; (a) displays the screen where a flash picture image by audition inspection, (b) depicts the enhanced screen of the selected picture image, (c) shows the screen which displays the applicant profile of the selected picture image. In the embodiment depicted, the picture of an applicant displayed by a screen display to display a plurality of applicants at the same time; it is assumed the layout of the picture images for the nine correspond to buttons from 1 to 9 of the cellular telephone. Here, the vote button can be displayed in the extended screen of the selection picture image.

When the nine picture images are displayed in the same screen, there are different individuals in the foreground, because a person is displayed in the good location and a vote is decided by reason of treasure and is merely against the purpose of the audition, for example, after having given a number (1-9) corresponding to cellular phone buttons supported the picture images for nine, although it is conceivable that the selection screen can be comprised in which the images meander and move like the raster scan of the television screen, and do not depend on the picture image location.

In addition, verification whether or not selection was correct becomes easy because a selected picture image can be relocated in the middle of the screen when one is selected from nine picture image shares that a voter gave the number that made a button from 1 to 9 of the cellular telephone provided, additionally a selected picture image maintains its picture image of the foreground and can be compared for the conclusion by making the remaining picture images of the eight rotate.

In FIG. 9(a), nine thumbnail flash images of the candidates from first to ninth are displayed. The cursor is matched to the display image of 7a, and when a specific button of input buttons 8 of cellular phone 4 is pressed or the image is expanded or for the case of a touch sensor panel, when the image of display 7a is pressed, the expansion screen is displayed on screen 7b in FIG. 9(b).

When specified button here is pushed, the display is switched from expansion image 7b to profile information screen 7c shown in FIG. 9(c). The voter can decide which applicant to vote for by reviewing the profiles of the nine candidates by choosing expansion screen 7b and profile information screen 7c. Although the voters can review the information for the flash image number selected, even if the user photographs the image with another digital camera, since the flash image and the profile are not displayed on the same screen together, the possibility of improper use of personal information can be reduced.

### INDUSTRIAL APPLICABILITY

Since the cellular phone has high market penetration and is easy to use, using it to carry out a voting examination with two or more stages running concurrently and simultaneously, the higher levels of the voting process can be carried out earlier and the examination time as a whole can be decreased, it is possible to arrive at a resultant selection in a shortened period of time, and because the number of the applicants and voters of the audition can be both increased, the audition system has a positive cost performance ratio can be offered with out the requirement of an expensive dedicated system.

### EXPLANATIONS OF THE LETTERS AND NUMERALS

1. Network; 2. Cell Phone Base Station; 3. Base Station Antenna; 4. Cell Phone Handsets; 5. Application Server; 6. Database; 7a, 7b, 7c. Cell Phone Handset Display; 8 Cell Phone Handset Input Button; 9 Header Image; 10 Applicant Photograph 1; 12 Applicant Photograph 2; 13 Applicant Photograph 3; 14. Footer Image; 15. Flash Image.

1. An audition system using a cellular telephone including:
a cellular telephone having an ID and an application server connected to the internet,
the application server having a central processing unit which executes programs of the application of the audition and the vote,
at each phase of examination the program divides a plurality of applicants and comprises an examination group, applicants chosen at low-level examination are gathered for high-level examination, until final examination is reached by the method of the program,
the program prevents a multiple registrations from the same cellular telephone in the examination group unit by identifying the ID, and
the program performs examination of a high-level examination group once sufficient number of people are gathered from a low-level examination group for the high-level group at the same time the low-level are examined, on a first-in first-out basis.

2. The audition system of claim 1 further comprising;
an audition system using the cellular telephone that is characterized by the feature where the program performs parallel mode of application and a vote in examination stage of each phase.

3. An audition system comprising,
an application server connected via a network and a cellular phone having an ID;
the application server having a central processing unit to execute the vote program of the audition system;
said program, having a system that gathers applicants for a low level examination, for high level examination and for final examination is reached, and examination at each phase the plurality of applicants are divided in to examination groups and become the subject of vote;
said program prevents a multiple voting from the same cellular telephone in an examination group unit by identifying the ID,
the program performs a first-in first-out examination where the low-level examination continues in the middle of high-level examination whose examination group is composed of members gathered at the sage of low-level examination, which continues while the high-level examined, and whereby
said program excludes groups from being displayed when the examination is finished.
